(19) United States
(12) Patent Application Publication
(10) Pub. No.: US 2012/0118836 A1
(43) Pub. Date: May 17, 2012

(54) RETAINING BRACKET STRUCTURE

(76) Inventor: Lai-Shun WU, Kaohsiung City (TW)

(21) Appl. No.: 12/944,013

(22) Filed: Nov. 11, 2010

(51) Int. Cl. E05B 73/00

(52) U.S. Cl. 211/4

(57) ABSTRACT

A retaining bracket structure includes a main body and an insertion member. The main body includes a hang portion and a display portion. The display portion includes a plurality of engaging portions. Each engaging portion has a positioning hole therein and a plurality of positioning protrusions on an outer side thereof. The inserting portion includes a plurality of anti-theft engaging rods and fixing rods. Each anti-theft engaging rod is fixed to the positioning hole. Each fixing rod is against a top surface of a corresponding engaging portion of the main body. The positioning protrusions are engaged with an inner wall of a sleeve fitted on the engaging portion of the display portion of the main body, such that the sleeve is firmly positioned on the main body. The anti-theft engaging rod can prevent the sleeve from disengagement and theft, providing a steady connection and a better positioning effect.

### BACKGROUND OF THE INVENTION

1. Field of the Invention

The present invention relates to a retaining bracket structure, and more particularly to a retaining bracket structure for displaying hand tools.

2. Description of the Prior Art

A conventional sleeve base structure, as shown in FIG. 9, comprises a connection base (40) and a transverse rod (50). The connection base (40) comprises a connection portion (41) and a slide engaging portion (42). The connection portion (41) comprises a pair of resilient plates (410) at two sides thereof. Each resilient plate (410) has a protrusion (411) thereon. The transverse rod (50) has a slide engaging groove (51) thereon. The slide engaging portion (42) of the connection base (40) is coupled to the slide engaging groove (51) of the transverse rod (50), such that the connection base (40) can be transversely slid with respect to the transverse rod (50). A sleeve (30) is fitted on the connection portion (41) of the connection base (40). The protrusions (411) on the resilient plates (410) of the connection portion (41) are contact with the inner wall of the sleeve (30) to urge the resilient plates (411) to move inward. When the connection portion (41) enters an engaging portion (31) of the sleeve (30), the resilient plates (410) will engage with the edge of the engaging portion (31) of the sleeve (30). Thus, the sleeve (30) is coupled to the connection portion (41) of the connection base (40). However, the conventional sleeve base structure has the following problems:

1. Unstable connection: By the protrusions of the resilient plates to engage with the sleeve, it is easy to disengage the sleeve from the connection portion of the connection base when the sleeve is pulled longitudinally or shaken transversely.

2. Worse positioning effect: When the sleeve is connected to the connection portion of the connection base, the engaging portion of the sleeve may disengage from the protrusions of the resilient plates by an external turning force.

Accordingly, the inventor of the present invention has devoted himself based on his many years of practical experiences to solve the aforesaid problems.

### SUMMARY OF THE INVENTION

The primary object of the present invention is to provide a retaining bracket structure to prevent a sleeve from disengagement. The retaining bracket comprises a main body and an insertion member. The main body comprises a hang portion and a display portion. The display portion comprises a plurality of engaging portions. Each engaging portion has a positioning hole therein and a plurality of positioning protrusions on an outer side thereof. The inserting portion comprises a plurality of anti-theft engaging rods and a plurality of fixing rods. Each anti-theft engaging rod of the insertion member is fixed to the positioning hole of a corresponding engaging portion of the main body. Each fixing rod of the insertion member is against a top surface of a corresponding engaging portion of the main body.

Accordingly, each anti-theft engaging rod of the insertion member is fixed to the positioning hole of a corresponding engaging portion of the display portion of the main body. Each fixing rod of the insertion member is against the top surface of a corresponding engaging portion of the display portion of the main body. The positioning protrusions on the outer side of each engaging portion of the display portion of the main body are engaged with an inner wall of a sleeve which is fitted on the engaging portion of the display portion of the main body, such that the sleeve is firmly positioned on the main body. The anti-theft engaging rod can prevent the sleeve from disengagement and theft, providing a steady connection and a better positioning effect.

### BRIEF DESCRIPTION OF THE DRAWINGS

FIG. 1 is a perspective view according to the present invention;

FIG. 2 is an exploded view according to the present invention;

FIG. 3 is a cross-sectional view according to the present invention;

FIG. 4 is a cross-sectional view according to the present invention in an operating status;

FIG. 5 is a perspective view according to the present invention in an operating status;

FIG. 6 is a schematic view according to a first embodiment of the present invention;

FIG. 7 is a schematic view according to a second embodiment of the present invention;

FIG. 8 is a schematic view according to a third embodiment of the present invention; and

FIG. 9 is a schematic view of the prior art.

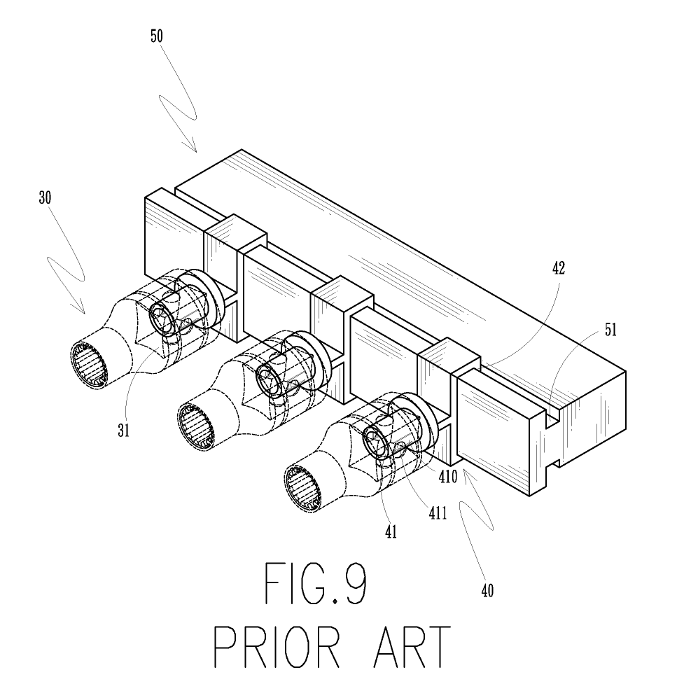

### DETAILED DESCRIPTION OF THE PREFERRED EMBODIMENTS

Embodiments of the present invention will now be described, by way of example only, with reference to the accompanying drawings.

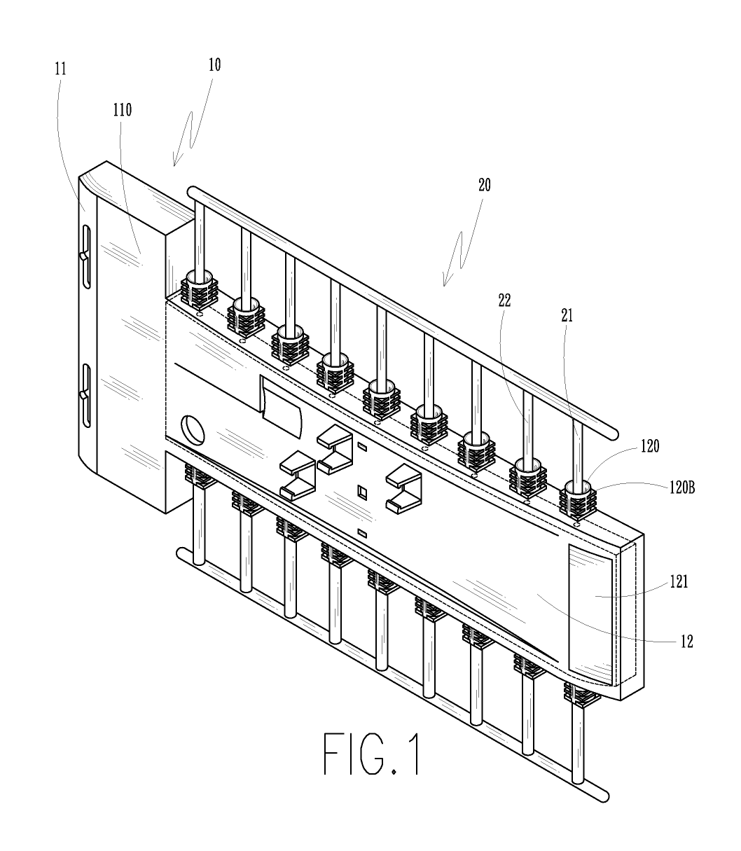

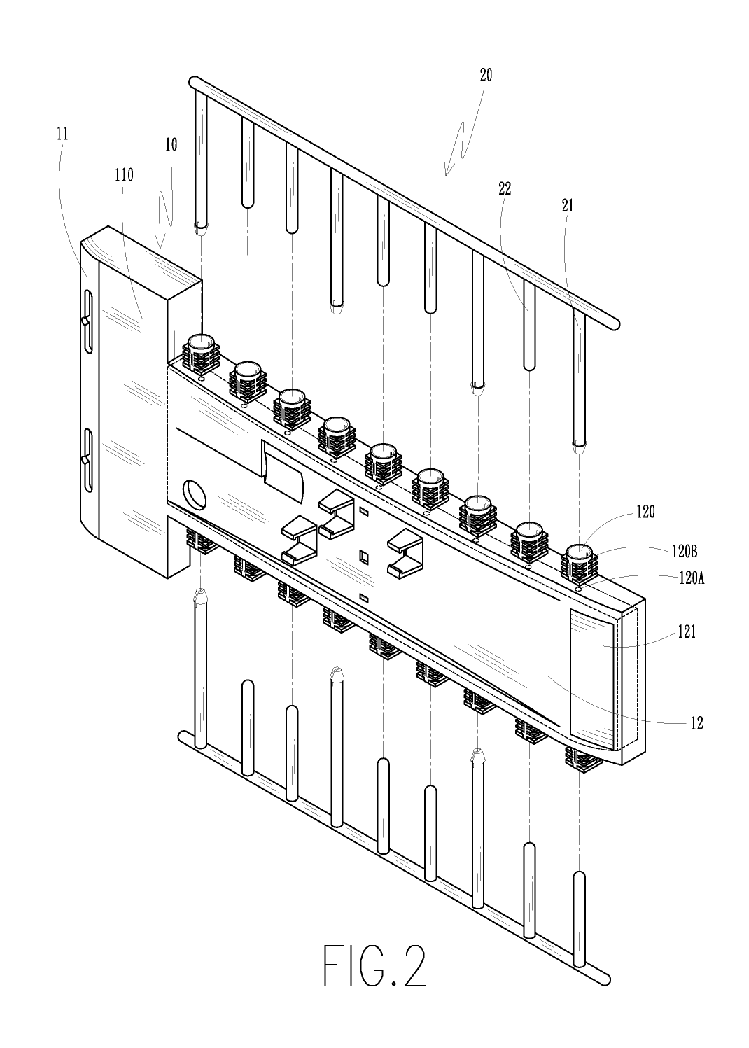

As shown in FIG. 1 through FIG. 3, a retaining bracket structure of the present invention comprises a main body (10) and an insertion member (20).

The main body (10) comprises a hang portion (11) and a display portion (12). The hang portion (11) includes a picture/character display part (110). Two sides of the display portion (12) are provided with a plurality of engaging portions (120) and a picture/character display part (121). Each engaging portion (120) has a positioning hole (120A) therein and a plurality of positioning protrusions (120B) on an outer side thereof. The positioning protrusions (120B) are disposed on the outer side of each engaging portion (120) and in a rectangular shape.

The insertion member (20) comprises a plurality of anti-theft engaging rods (21) and a plurality of fixing rods (22). Each anti-theft engaging rod (21) of the insertion member (20) is fixed to the positioning hole (120A) of a corresponding engaging portion (120) of the main body (10). Each fixing rod (22) of the insertion member (20) is against a top surface of a corresponding engaging portion (120) of the main body (10).

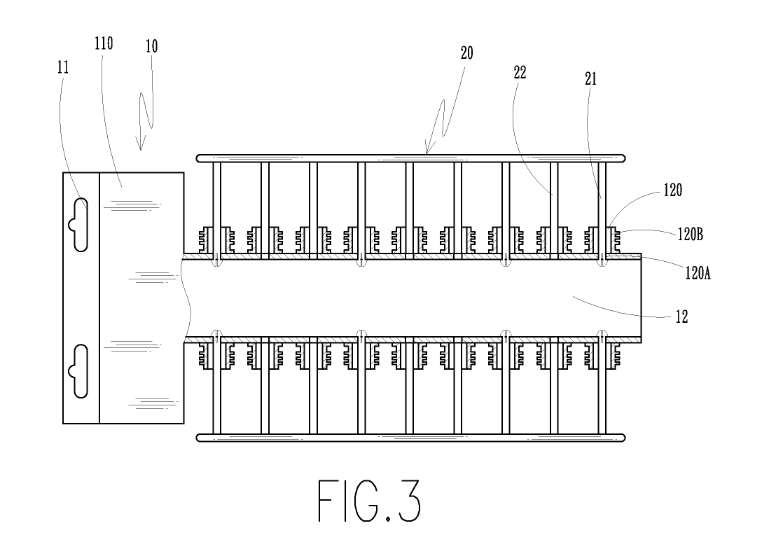

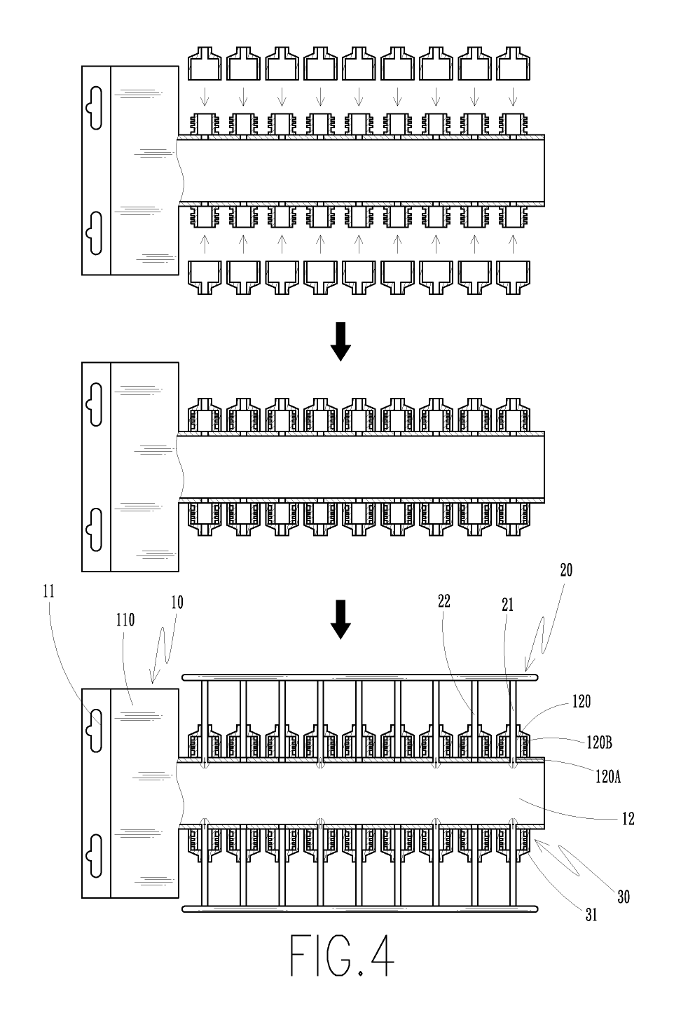

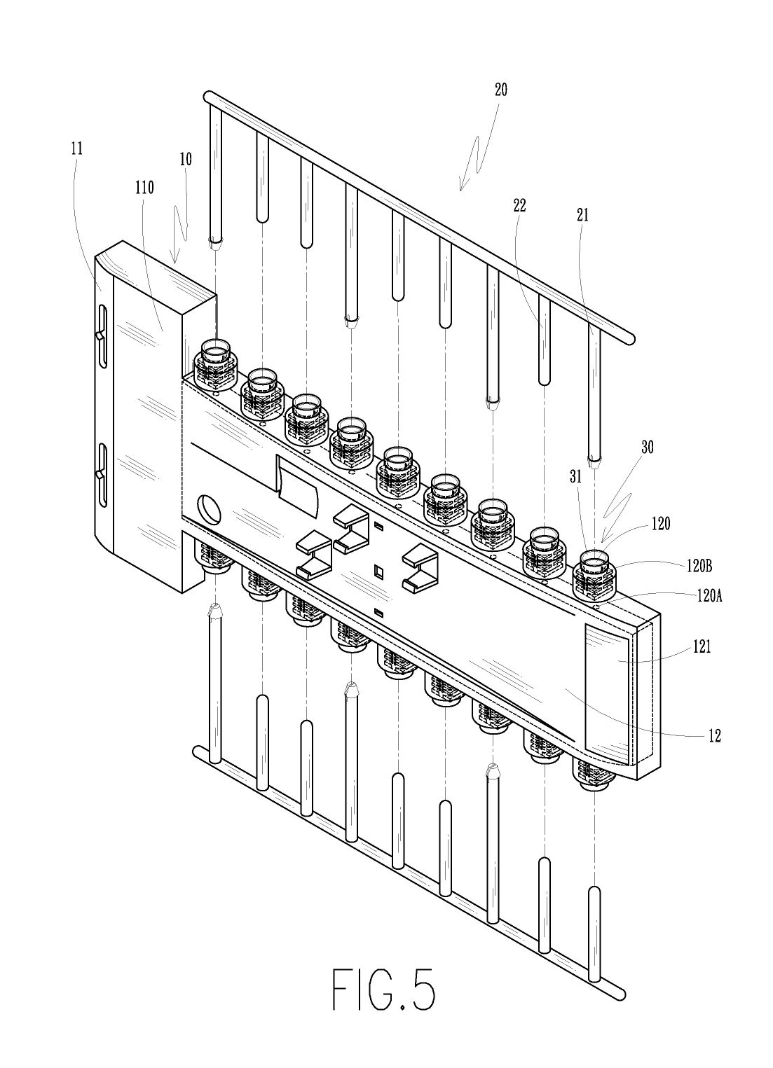

FIG. 3 is a cross-sectional view according to the present invention. FIG. 4 is a cross-sectional view according to the present invention in an operating status. FIG. 5 is a perspective view according to the present invention in an operating status. Each anti-theft engaging rod (21) of the insertion member (20) is fixed to the positioning hole (120A) of a corresponding engaging portion (120) of the display portion (12) of the main body (10). Each fixing rod (22) of the insertion member (20) is against the top surface of a corresponding engaging portion (120) of the display portion (12) of the main body (10). The positioning protrusions (120B) on the outer side of each engaging portion (120) of the display portion (12) of the main body (10) are engaged with an inner wall of a sleeve (30) which is fitted on the engaging portion (120) of the display portion (12) of the main body (10), such that the sleeve (30) is firmly positioned on the main body (10). The anti-theft engaging rod (21) can prevent the sleeve (30) from disengagement and theft, providing a steady connection and a better positioning effect.

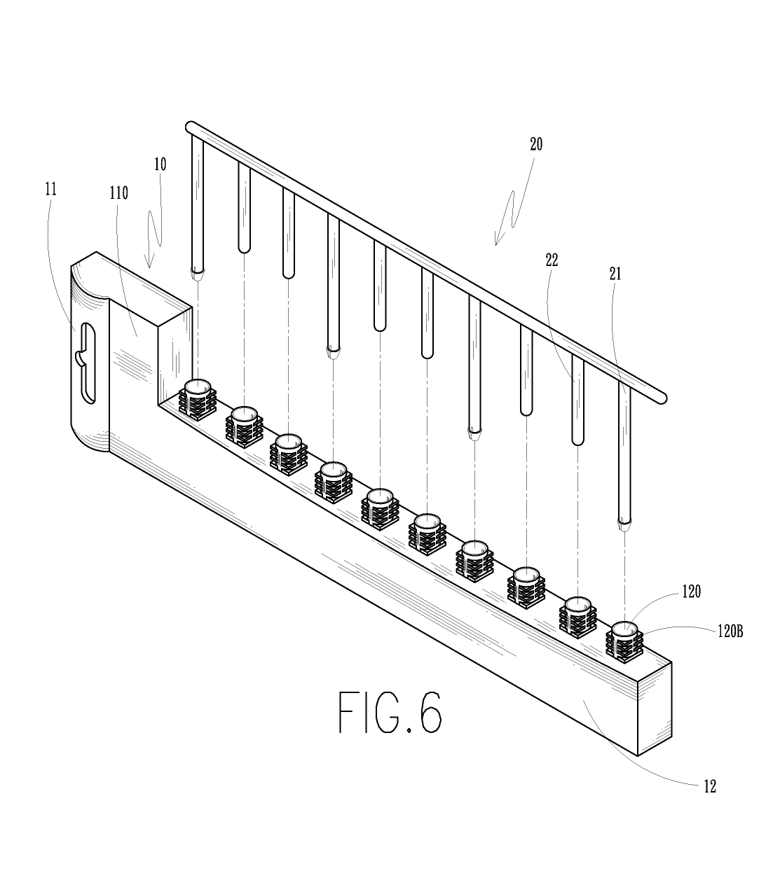

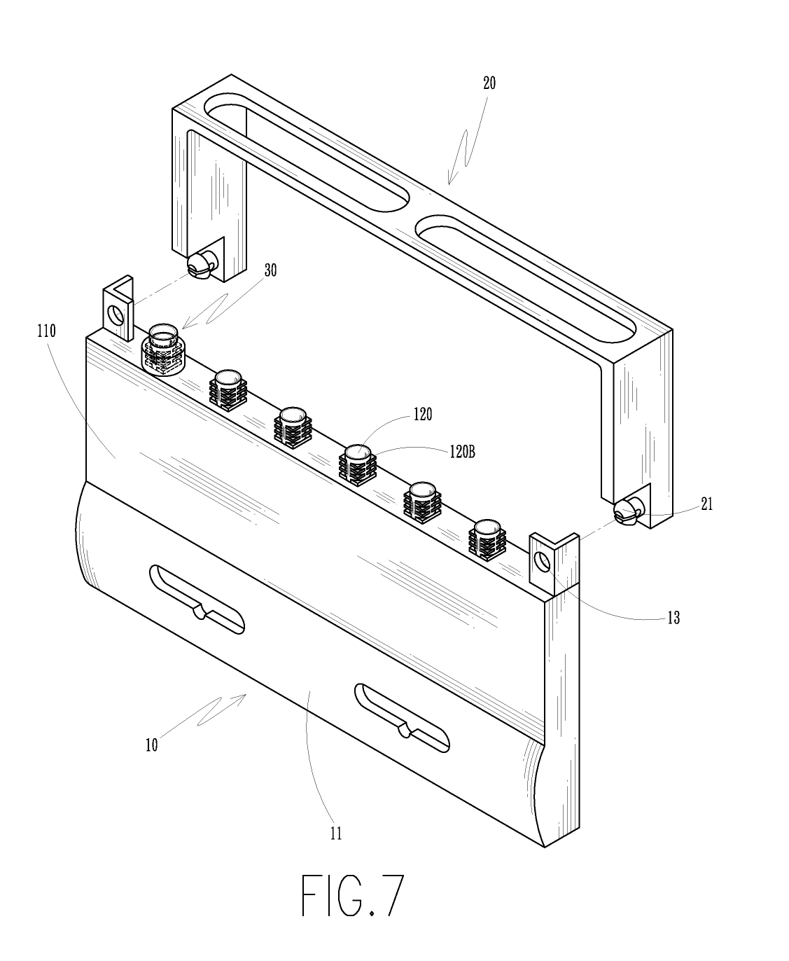

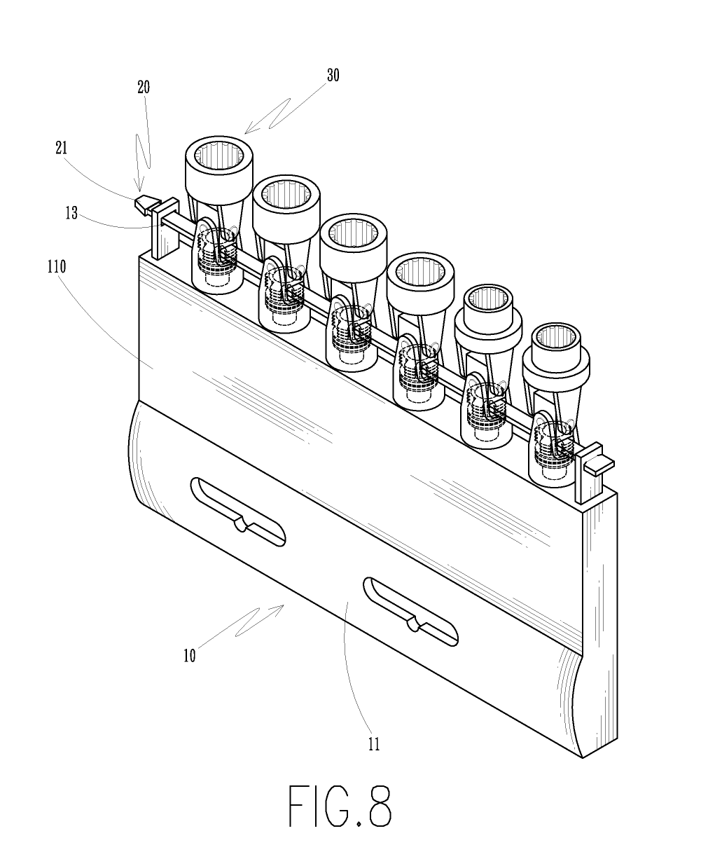

FIG. 6, FIG. 7 and FIG. 8 are schematic views to show preferred embodiments of the present invention as shown in FIG. 1 through FIG. 3, which are substantially similar to FIG. 1 through FIG. 5 with the exceptions described hereinafter. The engaging portions (120) are disposed at one side of the display portion (12). The main body (10) may have a plurality of engaging holes (13) thereon. The positioning protrusions (120B) on the outer side of each engaging portion (120) of the display portion (12) of the main body (10) are engaged with the inner wall of the sleeve (30) which is fitted on the engaging portion (120) of the display portion (12) of the main body (10), and the anti-theft engaging rod (21) is coupled to the engaging hole (13) of the main body (10), such that the sleeve (30) is firmly positioned on the main body (10). The anti-theft engaging rod (21) can prevent the sleeve (30) from disengagement and theft, providing a steady connection and a better positioning effect.

The present invention has the following advantages.

1. Stable connection. Each anti-theft engaging rod of the insertion member is fixed to the positioning hole of a corresponding engaging portion of the display portion of the main body. Each fixing rod of the insertion member is against the top surface of a corresponding engaging portion of the display portion of the main body. The positioning protrusions on the outer side of each engaging portion of the display portion of the main body are engaged with the inner wall of the sleeve which is fitted on the engaging portion of the display portion of the main body, such that the sleeve is firmly positioned on the main body to provide a stable connection.

2. Better positioning effect. The positioning protrusions of the engaging portion are engaged with the inner wall of the sleeve, with thorn teeth or angular teeth in the sleeve to confine and position the positioning protrusions of the engaging portion to provide a better positioning effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A retaining bracket structure, comprising:
a main body, the main body comprising a hang portion and a display portion, the display portion comprising a plurality of engaging portions, the engaging portions each having a positioning hole therein and a plurality of positioning protrusions on an outer side thereof, and
an insertion member, the inserting portion comprising a plurality of anti-theft engaging rods and a plurality of fixing rods, the anti-theft engaging rod of the insertion member each being fixed to the positioning hole of a corresponding engaging portion of the main body, the fixing rods of the insertion member each being against a top surface of a corresponding engaging portion of the main body.

2. The retaining bracket structure as claimed in claim 1, wherein the positioning protrusions are disposed on the outer side of each engaging portion and in a rectangular shape.

3. The retaining bracket structure as claimed in claim 1, wherein the hang portion includes a picture/character display part.

4. The retaining bracket structure as claimed in claim 1, wherein the display portion comprises a picture/character display part.

5. The retaining bracket structure as claimed in claim 1, wherein the engaging portions are disposed at one side of the display portion of the main body.

6. The retaining bracket structure as claimed in claim 1, wherein the engaging portions are disposed at two sides of the display portion of the main body.

7. A retaining bracket structure, comprising:
a main body, the main body comprising a hang portion and a display portion, and a plurality of engaging holes, the display portion comprising a plurality of engaging portions, the engaging portions each having a plurality of positioning protrusions on an outer side thereof, and
an insertion member, the inserting portion comprising a plurality of anti-theft engaging rods, the anti-theft engaging rods of the insertion member being inserted in the plurality of engaging holes of the main body.

8. The retaining bracket structure as claimed in claim 7, wherein the positioning protrusions are disposed on the outer side of each engaging portion and in a rectangular shape.

9. The retaining bracket structure as claimed in claim 7, wherein the hang portion includes a picture/character display part.
